(19) United States
(12) Patent Application Publication
(10) Pub. No.: US 2026/0341812 A1
(43) Pub. Date: Oct. 29, 2026

(54) BATTERY MANAGEMENT MODULE AND BATTERY MANAGEMENT SYSTEM USING THE SAME

(71) Applicant: Nanjing Silergy Micro Technology Co., Ltd., Nanjing (CN)

(72) Inventors: Wei Li, Nanjing (CN); Peiqi Chen, Nanjing (CN); Quanqing Hu, Nanjing (CN)

(21) Appl. No.: 19/648,666

(22) Filed: Apr. 15, 2026

(30) Foreign Application Priority Data
Apr. 24, 2025 (CN) 202510527361.X

(51) Int. Cl. H01M 10/42; H02J 7/00; H02J 7/84

(52) U.S. Cl. CPC H01M 10/4264; H02J 7/84; H02J 7/855; H01M 2010/4271; H01M 2010/4278; H02J 2207/20

(57) ABSTRACT

A battery management module can include: a switch circuit, coupled between a positive electrode of a battery and a positive output terminal of the battery management module, and being configured to charge or discharge the battery; an analog front-end chip, configured to monitor information of the battery, where the information of the battery comprises at least voltage information and current information of the battery; and where the analog front-end chip comprises a driving circuit configured to generate a driving signal for driving the switch circuit and a diagnostic circuit configured to diagnose a fault condition of the switch circuit.

### RELATED APPLICATIONS

This application claims the benefit of Chinese Patent Application No. 202510527361.X, filed on Apr. 24, 2025, which is incorporated herein by reference in its entirety.

### FIELD OF THE INVENTION

The present invention generally relates to the field of power electronics, and more particularly, to battery management modules and systems.

### BACKGROUND

In recent years, the demand for lithium batteries in niche areas, such as two-wheelers, power tools, marine applications, and home energy storage, has exploded, with a strong trend toward replacing lead-acid batteries in all these areas. However, due to cost, technology, and other reasons, in fully electric vehicles that have transitioned to lithium power, the starting and stopping batteries (often referred to as "auxiliary batteries" or "small batteries") are still mostly 12V lead-acid batteries.

### BRIEF DESCRIPTION OF THE DRAWINGS

FIG. 1 is a schematic circuit diagram of a battery management module.

FIG. 2 is a schematic circuit diagram of an example battery management module, in accordance with embodiments of the present invention.

FIG. 3 is a schematic circuit diagram of a first example switch circuit, in accordance with embodiments of the present invention.

FIG. 4 is a schematic circuit diagram of a second example switch circuit, in accordance with embodiments of the present invention.

FIG. 5 is a schematic circuit diagram of a third example switch circuit, in accordance with embodiments of the present invention.

FIG. 6 is a schematic circuit diagram of an example driving circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

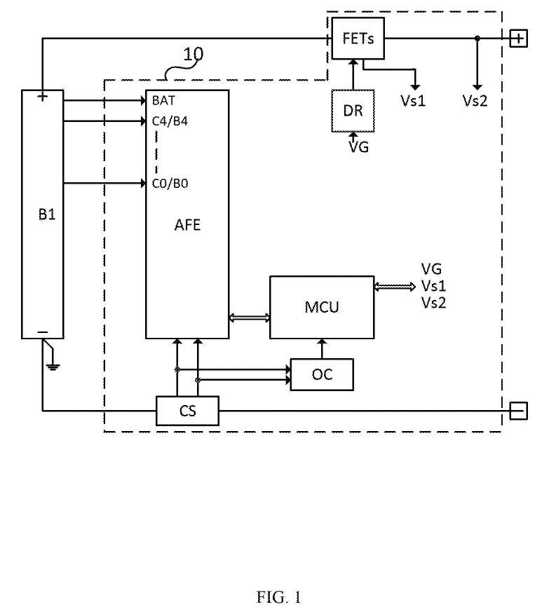

With the development of electric vehicles towards higher intelligence and as lithium battery technology matures and costs decrease, the transition of 12V on-board batteries to lithium has reached a turning point. Correspondingly, there is an emerging need for high-performance, low-power battery management systems and battery management modules. Referring now to FIG. 1, shown is a schematic circuit diagram of a battery management module. In this particular example, the battery management system can include battery management module 10 and battery B1. Battery management module 10 can include analog front-end chip AFE, microcontroller MCU, charge/discharge switch module FETs, driving module DR, overcurrent detection circuit OC, and current detection circuit CS. Analog front-end chip AFE can monitor the voltage, current, and temperature of battery B1 in real-time. Microcontroller MCU can be coupled to analog front-end chip AFE and may receive the information collected by analog front-end chip AFE for real-time analysis to support other functional requirements of the system.

In this example, on one hand, driving module DR for generating the driving signal for charge/discharge switch module FETs can be configured independently outside analog front-end chip AFE. When an abnormal situation occurs in the battery management system, analog front-end chip AFE may need to transmit the abnormal situation to microcontroller MCU. Then, microcontroller MCU may respond to the abnormal situation by transmitting a control signal instructing to turn off charge/discharge switch module FETs to driving module DR. Finally, driving module DR can generate a driving signal of a corresponding state to turn off charge/discharge switch module FETs. This may result in the battery management system being unable to cut off the load immediately when an abnormal situation occurs. Current detection circuit CS can be arranged between the negative electrode of the battery and the negative output terminal of the battery management module. Overcurrent detection circuit OC can also be independently arranged outside analog front-end chip AFE. Therefore, when an overcurrent event occurs, the system may not immediately turn off charge/discharge switch module FETs to cut off the load. On the other hand, a diagnostic module for diagnosing the fault condition of charge/discharge switch module FETs can be configured as discrete components and arranged inside microcontroller MCU. Consequently, sampling signals Vs1 and Vs2 generated by charge/discharge switch module FETs for fault diagnosis can be transmitted to microcontroller MCU. This may not only occupy resources of microcontroller MCU but also prevent microcontroller MCU from staying in a sleep or off state for a long time, thus making it difficult to achieve low power consumption.

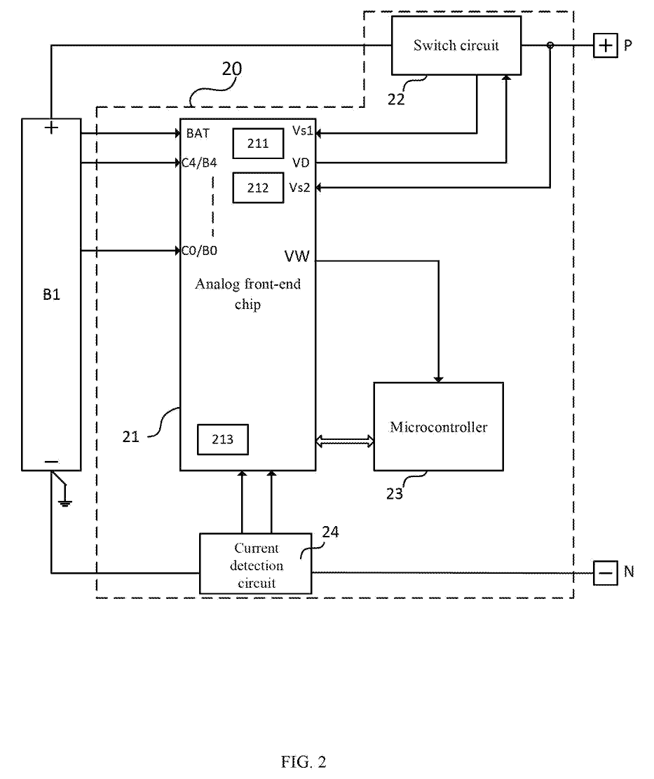

Referring now to FIG. 2, shown is a schematic circuit diagram of an example battery management module, in accordance with embodiments of the present invention. In this particular example, the battery management system can include battery management module 20 and battery B1. Battery management module 20 can include analog front-end chip 21, switch circuit 22, microcontroller 23, and current detection circuit 24. Those skilled in the art will recognize that the battery management system also can include other modules and circuits to implement battery management and control.

Battery B1 can include N cells connected in series, where the positive electrode of the highest potential cell can be coupled to positive output terminal P, the negative electrode of the lowest potential cell can be coupled to negative output terminal N, and the negative electrode of the lowest potential cell can connect to a reference ground. In this particular example, N=4 is used for illustration. In other examples, battery B1 may also include battery cells coupled in parallel.

Switch circuit 22 can be coupled between positive electrode of the battery B1 and positive output terminal P of the battery management module and can control the charging and discharging of battery B1. Analog front-end chip 21 can monitor at least the voltage information and current information of battery B1. For example, analog front-end chip 21 can measure various relevant cell state parameters (e.g., cell voltage, cell current, temperature of the cell, etc.) and diagnose whether the measurement results are faulty, in order to perform corresponding processing and control on the measurement results.

In particular embodiments, analog front-end chip 21 can also include driving circuit 211, diagnostic circuit 212, and overcurrent protection circuit 213. Driving circuit 211 can generate driving signal VD for driving switch circuit 22. For example, diagnostic circuit 212 can diagnose the fault condition of switch circuit 22, in order to determine whether there is a short circuit condition or an open circuit condition. The driving circuit and the diagnostic circuit can be integrated into the analog front-end chip. Because driving circuit 211 of switch circuit 22 can be configured inside analog front-end chip 21, when analog front-end chip 21 detects any abnormal situation requiring switch circuit 22 to be turned off, the abnormal situation can be transmitted to driving circuit 211 within analog front-end chip 21 immediately, in order to turn off switch circuit 22 by changing the level state of driving signal VD, and thereby achieving a rapid response to the abnormal situation.

Overcurrent protection circuit 213 may receive the current detection signal sampled by current detection circuit 24 to perform overcurrent detection. When an overcurrent of battery B1 is detected, switch circuit 22 can be turned off. Since overcurrent protection circuit 213 is configured inside analog front-end chip 21, when an overcurrent event occurs, overcurrent protection circuit 213 can directly transmit an overcurrent indication signal to driving circuit 211, in order to directly turn off switch circuit 22 by changing the level state of driving signal VD, thereby achieving a rapid response to the overcurrent event. This is unlike the comparative example in FIG. 1, whereby analog front-end chip 21 first needs to transmit the overcurrent situation to microcontroller 23, then microcontroller MCU responds to the abnormal situation by transmitting a control signal instructing to turn off switch circuit 22 to discrete driving module DR, and finally driving module DR can generate a driving signal to turn off switch circuit 22. Therefore, the battery management module of particular embodiments can quickly respond to various abnormal situations and turn off switch circuit 22.

Microcontroller 23 can be coupled to analog front-end chip 21 and may perform real-time arithmetic processing on analog signals (e.g., voltage, temperature, and current, etc.) of the battery collected by analog front-end chip 21, and implementing core algorithms (e.g., state of charge (SOC) estimation, charge/discharge management, balancing control, etc.). Optionally, microcontroller 23 can communicate with analog front-end chip 21, a host controller, and other controllers via interfaces (e.g., SPI/CAN-FD) to build a complete battery monitoring network. If microcontroller 23 is always in a normal operating state, its power consumption may be very high. In battery management module 20 of particular embodiments, because driving circuit 211, diagnostic circuit 212, and overcurrent protection circuit 213 are all arranged in analog front-end chip 21, microcontroller 23 can remain in a sleep state for a longer time. Moreover, when a system abnormality is detected, analog front-end chip 21 can generate wake-up signal VW to cause microcontroller 23 to transition from the sleep state to the normal operating state, such that microcontroller 23 can further check the abnormality and take corresponding actions. Thus, the power consumption of microcontroller 23 can be greatly reduced, enabling the system to meet low power consumption requirements.

In particular embodiments, analog front-end chip 21 can also include wake-up pin VW for communicating with microcontroller 23, configured to output wake-up signal VW to cause microcontroller 23 to enter a normal operating mode when a system abnormality is detected. Further, analog front-end chip 21 can also include a set of output pins for outputting driving signal VD of switch circuit 22 (here indicated by pin VD), and a set of input pins for receiving sampling signals related to switch circuit 22 (here indicated by pins Vs1 and Vs2). In the battery management module of particular embodiments, the driving circuit and the diagnostic circuit for the switch circuit can be arranged inside the analog front-end chip. Thus, on one hand, when a system abnormality occurs or the switch circuit fails, the battery management module can cut off the switch circuit to disconnect the load within a relatively short time. On the other hand, the microcontroller can remain in a sleep state for a longer period, significantly reducing its power consumption, thereby enabling the system to meet low power consumption requirements. Simultaneously, due to the above configuration, the configuration of microcontroller 23 may also be simplified, as it does not need to be provided with pins related to the driving signal of switch circuit 22, nor does it need to be provided with pins for sampling signals related to the fault diagnosis of switch circuit 22.

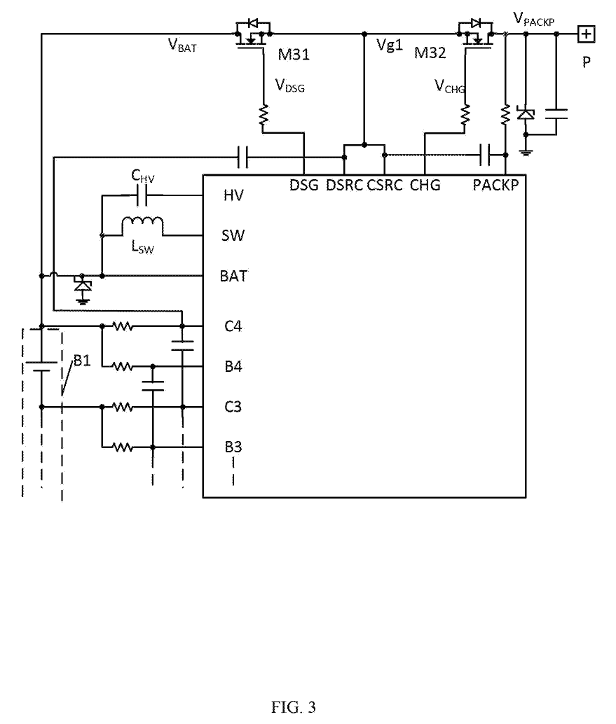

Referring now to FIG. 3, shown is a schematic circuit diagram of a first example switch circuit, in accordance with embodiments of the present invention. In this particular example, a set of output pins of the analog front-end chip for outputting driving signal VD of switch circuit 22 are pins DSG and CHG, and a set of input pins for receiving sampling signals related to switch circuit 22 are pins DSRC/CSRC, PACKP, and BAT. For example, switch circuit 22 can include transistors M31 and M32 connected in series between the positive electrode of the battery and the positive output terminal of the battery management module, and body diodes of transistors M31 and M32 can connect in opposite directions to achieve bidirectional current blocking. For example, transistors M31 and M32 can connect with a common source. A drain of transistor M31 can be coupled to the positive electrode of battery B1, a source of transistor M31 can connect to a source of transistor M32, and a drain of transistor M32 can be coupled to positive output terminal P of the battery management module.

It should be noted that the transistors in particular embodiments are N-type metal oxide semiconductor field effect transistors (MOSFETs). It should be understood that other electrically controlled switching devices, such as bipolar junction transistors (BJTs) or insulated gate bipolar transistors (IGBTs), can also serve as the transistors of particular embodiments.

In this example, transistor M31 can be a discharge transistor, and transistor M32 can be a charge transistor. Here, a discharge transistor may mean that the discharge transistor must be turned on to form a complete discharge path when battery B1 needs to discharge to a load. For example, when transistor M31 is turned on, a discharge path can be formed by battery B1-transistor M31-transistor M32/body diode of transistor M32-load. If transistor M31 remains off, no discharge path can be formed. A charge transistor may mean that the charge transistor must be turned on to form a complete charge path when the load needs to charge battery B1. For example, when transistor M32 is turned on, a charge path can be formed by load-transistor M32-transistor M31/body diode of transistor M31-battery B1. If transistor M32 remains off, no charge path can be formed.

Transistor M31 can be controlled by driving signal V_{DSG}, and driving signal V_{DSG} can be transmitted to the gate of transistor M31 through pin DSG. Transistor M32 can be controlled by driving signal V_{CHG}, and driving signal V_{CHG} can be transmitted to the gate of transistor M32 through pin CHG. Driving reference voltage V_{DSRC} (e.g., transmitted through pin DSRC) of driving signal V_{DSG} and driving reference voltage V_{CSRC} (e.g., transmitted through pin CSRC) of driving signal V_{CHG} may both be configured as source voltage Vg1 of the common source of transistors M31 and M32. Driving signals V_{DSG} and V_{CHG} can respectively drive transistors M31 and M32 to perform discharge control and charge control of battery B1, and driving signals V_{DSG} and V_{CHG} can be independent of each other.

As shown in FIG. 3, in order to make the voltages of the cells of battery B1 sampled by various ports more stable, each voltage sampling port Ci and each voltage sampling port Bi may respectively be coupled to the electrode of corresponding cell via a low-pass filter. It can be understood that the low-pass filter can be any low-pass filter circuit known in the art, and the simplest low-pass circuit is exemplified as the RC filter circuit shown in FIG. 3.

For example, diagnostic circuit 212 may sample drain voltage V_{BAT} of transistor M31 (e.g., transmitted through pin BAT), drain voltage V_{PACKP} of transistor M32 (e.g., transmitted through pin PACKP), and common node voltage Vg1 of the common node of transistors M31 and M32 to perform fault judgment. When all transistors in switch circuit 22 are turned on, the following can occur. When an absolute value of a difference between drain voltage V_{BAT} of transistor M31 and common node voltage Vg1 is near zero, this may indicate a short circuit condition of transistor M31. When an absolute value of a difference between the drain voltage V_{PACKP} of transistor M32 and common node voltage Vg1 is near zero, this may indicate a short circuit condition of transistor M32. When the absolute value of the difference between drain voltage V_{BAT} of transistor M31 and common node voltage Vg1 is near a full-scale value, this may indicate an open circuit condition of transistor M31. When the absolute value of the difference between drain voltage V_{PACKP} of transistor M32 and common node voltage Vg1 is near a full-scale value, this may indicate an open circuit condition of transistor M32. Here, the full-scale value may refer to a maximum allowable bias voltage achievable by the chip under specific operating conditions, which is a key parameter to ensure normal operation and reliability of the chip.

In switch circuit 22 of this example, because transistors M31 and M32 are controlled by different and independent driving signals, it can support independently disabling one of the transistors and may also support enabling only the charging function or only the discharging function. Moreover, because transistors M31 and M32 can connect with a common source, the battery management circuit can monitor three voltages (e.g., drain voltage V_{BAT} of transistor M31, drain voltage V_{PACKP} of transistor M32, and common node voltage Vg1) for fault judgment.

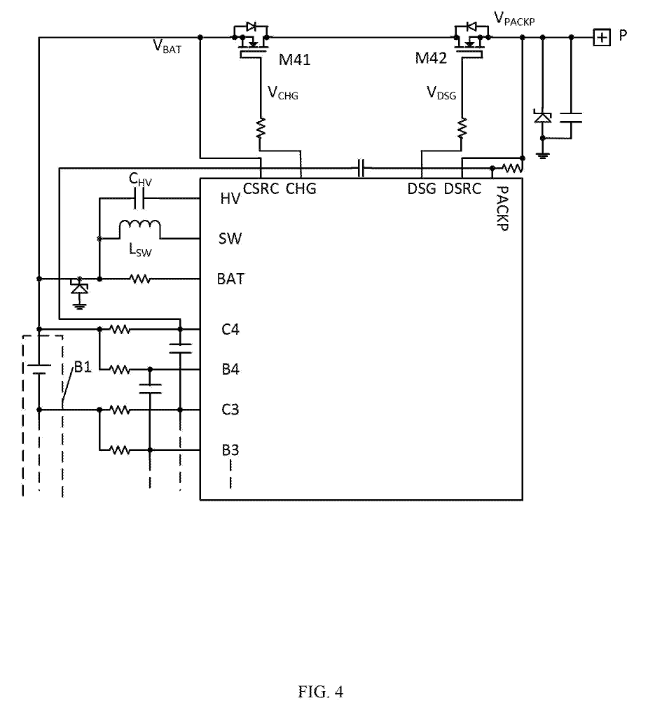

Referring now to FIG. 4, shown is a schematic circuit diagram of a second example switch circuit, in accordance with embodiments of the present invention. In this particular example, switch circuit 22 can include transistors M41 and M42 connected in series between the positive electrode of the battery and the positive output terminal of the battery management module, and body diodes of transistors M41 and M42 connected in opposite directions to achieve bidirectional current blocking. For example, transistors M41 and M42 can connect with a common drain. A source of transistor M41 can be coupled to the positive electrode of battery B1, a drain of transistor M41 can connect to a drain of transistor M42, and a source of transistor M42 can be coupled to positive output terminal P of the battery management module. In particular embodiments, transistor M41 can be configured as a charge transistor, and transistor M42 as a discharge transistor.

Transistor M42 can be controlled by driving signal V_{DSG}, and driving signal V_{DSG} can be transmitted to the gate of transistor M42 through pin DSG. Transistor M41 can be controlled by driving signal V_{CHG}, and driving signal V_{CHG} can be transmitted to the gate of transistor M41 through pin CHG. Driving reference voltage V_{DSRC} (e.g., transmitted through pin DSRC) of driving signal V_{DSG} and driving reference voltage V_{CSRC} (e.g., transmitted through pin CSRC) of driving signal V_{CHG} may both be configured as a source voltage of the respective transistor. Driving signals V_{DSG} and V_{CHG} can respectively drive transistors M41 and M42 to perform discharge control and charge control of battery B1, and driving signals V_{DSG} and V_{CHG} may be independent of each other.

For example, diagnostic circuit 212 may sample source voltage V_{BAT} of transistor M41 (e.g., transmitted through pin BAT) and source voltage V_{PACKP} of transistor M42 (e.g., transmitted through pin PACKP) to perform fault judgment. Further, when all transistors in switch circuit 22 are turned on, the following can occur. When an absolute value of a difference between source voltage V_{BAT} of transistor M41 and source voltage V_{PACKP} of transistor M42 is near zero, this may indicate a short circuit condition in switch circuit 22. When the absolute value of the difference between source voltage V_{BAT} of transistor M41 and source voltage V_{PACKP} of transistor M42 is near a full-scale value, this may indicate an open circuit condition in switch circuit 22. Here, the full-scale value may refer to a maximum allowable bias voltage achievable by the chip under specific operating conditions, which is a key parameter to ensure normal operation and reliability of the chip.

In switch circuit 22 of this example, because transistors M41 and M42 are controlled by different and independent driving signals, it can support independently disabling one of the transistors, and may also support enabling only the charging function or only the discharging function. Also, because transistors M41 and M42 can connect with a common source, it can support a relatively flexible transistor turn-on sequence, meaning that whichever transistor is turned on first does not affect the turn-on of the other transistor.

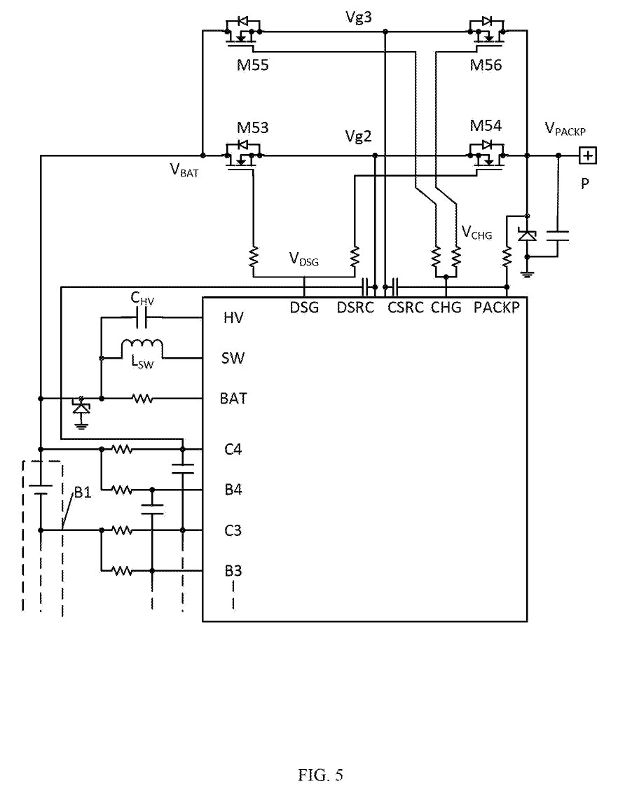

Referring now to FIG. 5, shown is a schematic circuit diagram of a third example switch circuit, in accordance with embodiments of the present invention. In this particular example, the structure of switch circuit 22 can include a first switch branch including transistors M53 and M54 connected in series, and second switch branch including transistors M55 and M56 connected in series. The first and second switch branches can connect in parallel. The first switch branch can be controlled by one of driving signals V_{DSG} and V_{CHG}, and the second switch branch can be controlled by the other of driving signals V_{DSG} and V_{CHG}. Body diodes of transistors M53 and M54 can connect in opposite directions, and body diodes of transistors M55 and M56 are connected in opposite directions, in order to achieve bidirectional current blocking.

For example, transistors M53 and M54 can connect with a common source. A drain of transistor M53 can be coupled to the positive electrode of battery B1, a source of transistor M53 can connect to a source of transistor M54, and a drain of transistor M54 can be coupled to positive output terminal P of the battery management module. Transistors M55 and M56 can connect with a common source. A drain of transistor M55 can be coupled to the positive electrode of battery B1, a source of transistor M55 can connect to a source of transistor M56, and a drain of transistor M56 can be coupled to positive output terminal P of the battery management module. In this particular example, one of the first switch branch and the second switch branch can be configured as a discharge branch, and the other of the first switch branch and the second switch branch can be configured as a charge branch. Here, the first switch branch can be configured as the discharge branch, and the second switch branch can be configured as the charge branch. The discharge branch can be turned on when the battery B1 needs to discharge to a load, and the charge branch can be turned on when battery B1 needs to be charged by a load.

The first switch branch can be controlled by driving signal V_{DSG}, and driving signal V_{DSG} can be transmitted to the gates of transistors M53 and M54 through pin DSG. The second switch branch can be controlled by driving signal V_{CHG}, and driving signal V_{CHG} can be transmitted to the gates of transistors M55 and M56 through pin CHG. Driving reference voltage V_{DSRC} (e.g., transmitted through pin DSRC) of driving signal V_{DSG} can be configured as source voltage Vg2 of the common source of transistors M53 and M54. Driving reference voltage V_{CSRC} (e.g., transmitted through pin CSRC) of driving signal V_{CHG} can be configured as source voltage Vg3 of the common source of transistors M55 and M56. Driving signals V_{DSG} and V_{CHG} can respectively drive the first and second switch branches to perform discharge control and charge control of battery B1 and driving signals V_{DSG} and V_{CHG} can be independent of each other.

For example, diagnostic circuit 212 may sample drain voltage V_{BAT} of transistor M53 or transistor M55 (e.g., transmitted through pin BAT), drain voltage V_{PACKP} of transistor M54 or transistor M56 (e.g., transmitted through pin PACKP), common node voltage Vg2 of the common node of transistors M53 and M54, and common node voltage Vg3 of the common node of transistors M55 and M56, in order to perform fault judgment. When all transistors in one branch are turned on, the following can occur. When an absolute value of a difference between the drain voltage of a corresponding transistor and the corresponding common node voltage can be near zero, this may indicate a short circuit condition of the corresponding transistor. When the absolute value of the difference between the drain voltage of the corresponding transistor and the corresponding common node voltage can be near a full-scale value, this may indicate an open circuit condition of the corresponding transistor.

Further, the following can occur when all transistors in switch circuit 22 are turned on. When an absolute value of a difference between drain voltage V_{BAT} or drain voltage V_{PACKP} and common node voltage Vg2 can be near zero, this may indicate a short circuit condition of transistor M53 or transistor M54. When an absolute value of a difference between drain voltage V_{BAT} or drain voltage V_{PACKP} and common node voltage Vg3 can be near zero, this may indicate a short circuit condition of transistor M55 or transistor M56. When the absolute value of the difference between drain voltage V_{BAT} or drain voltage V_{PACKP} and common node voltage Vg2 can be near a full-scale value, this may indicate an open circuit condition of transistor M53 or transistor M54. When the absolute value of the difference between drain voltage V_{BAT} or drain voltage V_{PACKP} and common node voltage Vg3 can be near a full-scale value, this may indicate an open circuit condition of transistor M55 or transistor M56. Here, the full-scale value refers to a maximum allowable bias voltage achievable by the chip under specific operating conditions, which can be a key parameter to ensure normal operation and reliability of the chip.

In switch circuit 22 of this example, because the first and second switch branches are controlled by different and independent driving signals, it can support independently disabling one of the switch branches. Also, because the transistors within the same branch can connect with a common source, the battery management circuit can monitor four voltages (e.g., drain voltage V_{BAT}, drain voltage V_{PACKP}, common node voltage Vg2, and common node voltage Vg3) for fault judgment, making it possible to diagnose which specific transistor has which type of fault.

In conventional approaches, a single-ended sampling method can be commonly used. Because this sampling method makes it difficult to achieve synchronous sampling of different signals, and the diagnostic condition can be based on the difference between two sampled signals to determine the states of the transistor, this approach may lead to erroneous diagnosis due to the introduced transient interference. Further, diagnostic circuit 212 of the embodiments performs sampling using a differential sampling method. In particular embodiments, diagnostic circuit 212 may perform differential sampling, so different sampling signals are inherently synchronized, and the transients introduced during the sampling process can be canceled out and thus may not lead to erroneous diagnosis.

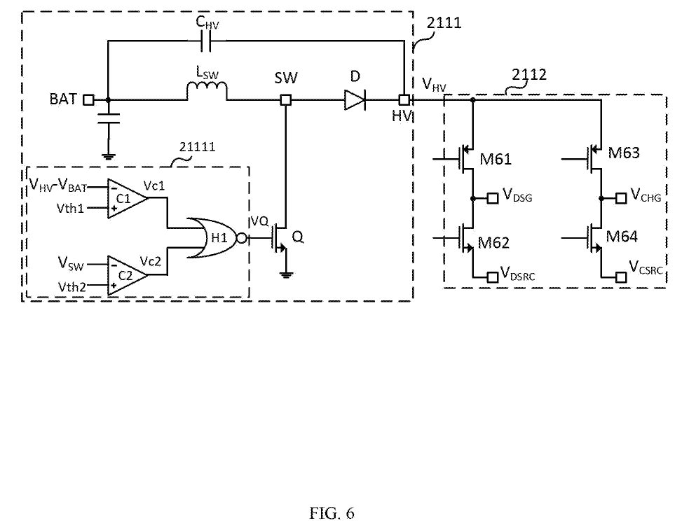

Referring now to FIG. 6, shown is a schematic circuit diagram of an example driving circuit, in accordance with embodiments of the present invention. In this particular example, driving circuit 211 can include boost circuit 2111 and driving signal generation circuit 2112. Boost circuit 2111 may receive the voltage of battery B1 and boost the voltage of battery B1 to voltage V_{HV} matching the driving signal of switch circuit 22. Driving signal generation circuit 2112 may receive voltage V_{HV} and can generate driving signals V_{DSG} and V_{CHG} according to control signals for switch circuit 22.

For example, boost circuit 2111 can include capacitor C_{HV} and inductor L_{SW} external to the analog front-end chip, and transistor Q and diode D internal to the analog front-end chip. Inductor L_{SW} and transistor Q can be coupled in series between an input terminal of the boost circuit and a ground terminal, diode D can be coupled between a common terminal of inductor L_{SW} and transistor Q and an output terminal of the boost circuit, capacitor C_{HV} can connect across an input terminal and an output terminal of the boost circuit, and capacitor C_{HV} can maintain the value of voltage V_{HV}.

Boost circuit 2111 can also include logic circuit 21111. Logic circuit 21111 controls transistor Q to turn off when a difference between voltage V_{HV} and voltage V_{BAT} of battery B1 can be less than threshold Vth1. When the difference between voltage V_{HV} and voltage V_{BAT} of battery B1 is less than threshold Vth1, this may indicate that the voltage on first capacitor C_{HV} is relatively low. After turning off transistor Q, the voltage on capacitor C_{HV} can be charged up until it meets the amplitude requirement of the driving voltage. Alternatively, logic circuit 21111 can control transistor Q to turn off when voltage V_{SW} at a switching node is less than threshold Vth2. When voltage V_{SW} at the switching node is less than threshold Vth2, it indicates that the current through capacitor C_{HV} is relatively small. After turning off transistor Q, the current through capacitor C_{HV} can be increased. Switching node SW can be the common node of inductor L_{SW} and transistor Q.

In particular embodiments, logic circuit 21111 can include comparator C1, comparator C2, and NOR gate H1. Comparator C1 can output comparison signal Vc1 in an active state when the difference between voltage V_{HV} and voltage V_{BAT} of battery B1 is less than threshold Vth1. Comparator C2 can output comparison signal Vc2 in an active state when voltage V_{SW} at the switching node is less than threshold Vth2. NOR gate H1 can output control signal VQ in an inactive state when either comparison signal Vc1 or comparison signal Vc2 is in an active state. Control signal VQ in the inactive state can cause transistor Q to turn off.

In particular embodiments, driving signal generation circuit 2112 can include first and second half-bridge circuits. Here, the first half-bridge circuit can include transistors M61 and M62 connected in series. One terminal of transistor M61 may receive voltage V_{HV}, and the other terminal of transistor M61 can connect to one terminal of transistor M62. The other terminal of transistor M62 may receive driving reference voltage V_{DSRC}. The first half-bridge circuit can turn on or off transistors M61 and M62 according to an active state of a first control signal for switch circuit 22, thus generating driving signal V_{DSG} at a common node of transistors M61 and M62. Similarly, the second half-bridge circuit can include transistors M63 and M64 connected in series. One terminal of transistor M63 may receive voltage V_{HV}, and the other terminal of transistor M63 can connect to one terminal of transistor M64. The other terminal of transistor M64 may receive driving reference voltage V_{CSRC}. The second half-bridge circuit can turn on or off transistors M63 and M64 according to an active state of a second control signal for switch circuit 22, thus generating driving signal V_{CHG} at a common node of transistors M63 and M64. Here, the first and second control signals can control the operation states of the transistors in the first half-bridge circuit and the second half-bridge circuit.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A battery management module, comprising:
a) a switch circuit, coupled between a positive electrode of a battery and a positive output terminal of the battery management module, and being configured to charge or discharge the battery;
b) an analog front-end chip, configured to monitor information of the battery, wherein the information of the battery comprises at least voltage information and current information of the battery; and
c) wherein the analog front-end chip comprises a driving circuit configured to generate a driving signal for driving the switch circuit and a diagnostic circuit configured to diagnose a fault condition of the switch circuit.

2. The battery management module of claim 1, further comprising a microcontroller coupled to the analog front-end chip, and being configured to receive the information of the battery collected by the analog front-end chip for real-time analysis.

3. The battery management module of claim 2, wherein the battery management module is configured to generate a wake-up signal to enable the microcontroller to enter a normal operating state from a sleep state when the analog front-end chip detects an abnormality.

4. The battery management module of claim 1, wherein the analog front-end chip further comprises an overcurrent detection circuit configured to turn off the switch circuit when an overcurrent of the battery is detected.

5. The battery management module of claim 1, wherein the switch circuit comprises a first transistor and a second transistor coupled in series between the positive electrode of the battery and the positive output terminal of the battery management module, and wherein body diodes of the first transistor and the second transistor are coupled in opposite directions.

6. The battery management module of claim 5, wherein:
a) a source of the first transistor is coupled to a source of the second transistor, the first transistor is configured as a discharge transistor, and the second transistor is configured as a charge transistor; and
b) the first transistor is controlled by a first driving signal, and the second transistor is controlled by a second driving signal.

7. The battery management module of claim 5, wherein:
a) a drain of the first transistor is coupled to a drain of the second transistor, the first transistor is configured as a charge transistor, and the second transistor is configured as a discharge transistor; and
b) the first transistor is controlled by a second driving signal, and the second transistor is controlled by a first driving signal.

8. The battery management module of claim 1, wherein the switch circuit comprises:
a) a first switch branch, comprising a third transistor and a fourth transistor coupled in series;
b) a second switch branch, comprising a fifth transistor and a sixth transistor coupled in series; and
c) wherein the first switch branch and the second switch branch are coupled in parallel, the first switch branch is controlled by one of a first driving signal and a second driving signal, and the second switch branch is controlled by the other of the first driving signal and the second driving signal.

9. The battery management module of claim 6, wherein the driving circuit comprises:
a) a boost circuit, configured to receive a voltage of the battery and boost the voltage of the battery to a first voltage matching driving signals of the switch circuit; and
b) a driving signal generation circuit, configured to receive the first voltage and generate the first driving signal and the second driving signal according to control signals for the switch circuit.

10. The battery management module of claim 9, wherein the boost circuit comprises:
a) a first capacitor and a first inductor, external to the analog front-end chip;
b) a third transistor and a first diode, internal to the analog front-end chip; and
c) wherein the first inductor and the third transistor are coupled in series between an input terminal of the boost circuit and a ground terminal, the first diode is coupled between a common terminal of the first inductor and the third transistor and an output terminal of the boost circuit, and the first capacitor is coupled between the input terminal and the output terminal of the boost circuit.

11. The battery management module of claim 10, wherein the third transistor is turned off when a difference between the first voltage and the voltage of the battery is less than a first threshold, or when a voltage at a switching node is less than a second threshold, and wherein the switching node is a common node of the first inductor and the third transistor.

12. The battery management module of claim 9, the driving signal generation circuit comprises:
a) a first half-bridge circuit, having a first terminal for receiving the first voltage, configured to generate the first driving signal according to a first control signal for the switch circuit; and
b) a second half-bridge circuit, having a first terminal for receiving the first voltage, configured to generate the second driving signal according to a second control signal for the switch circuit.

13. The battery management module of claim 12, wherein second terminals of the first half-bridge circuit and the second half-bridge circuit respectively receive a first driving reference voltage and a second driving reference voltage, and wherein each of the first driving reference voltage and the second driving reference voltage is configured as a source voltage of a respective transistor.

14. The battery management module of claim 6, wherein the diagnostic circuit samples a drain voltage of the first transistor, a drain voltage of the second transistor, and a first common node voltage of a common node of the first transistor and the second transistor to perform fault judgment.

15. The battery management module of claim 14, wherein when all transistors are turned on, wherein:
a) when an absolute value of a difference between the drain voltage of the first transistor and the first common node voltage is near zero, a short circuit condition of the first transistor is indicated;
b) when an absolute value of a difference between the drain voltage of the second transistor and the first common node voltage is near zero, a short circuit condition of the second transistor is indicated;
c) when the absolute value of the difference between the drain voltage of the first transistor and the first common node voltage is near a full-scale value, an open circuit condition of the first transistor is indicated;
d) when the absolute value of the difference between the drain voltage of the second transistor and the first common node voltage is near a full-scale value, an open circuit condition of the second transistor is indicated; and
e) the full-scale value is configured as a maximum allowable bias voltage under specific operating conditions.

16. The battery management module of claim 7, wherein the diagnostic circuit samples a source voltage of the first transistor and a source voltage of the second transistor to perform fault judgment.

17. The battery management module of claim 16, wherein when all transistors are turned on, wherein:
a) when an absolute value of a difference between the source voltage of the first transistor and the source voltage of the second transistor is near zero, a short circuit condition in the switch circuit is indicated;
b) when the absolute value of the difference between the source voltage of the first transistor and the source voltage of the second transistor is near a full-scale value, an open circuit condition in the switch circuit is indicated; and
c) the full-scale value is configured as a maximum allowable bias voltage under specific operating conditions.

18. The battery management module of claim 8, wherein the diagnostic circuit samples a drain voltage of the third transistor or the fifth transistor, a drain voltage of the fourth transistor or the sixth transistor, a second common node voltage of a common node of the third transistor and the fourth transistor, and a third common node voltage of a common node of the fifth transistor and the sixth transistor to perform fault judgment.

19. The battery management module of claim 18, wherein when all transistors in one branch are turned on, wherein:
a) when an absolute value of a difference between the drain voltage of a corresponding transistor and a corresponding common node voltage is near zero, a short circuit condition of the corresponding transistor is indicated;
b) when the absolute value of the difference between the drain voltage of the corresponding transistor and the corresponding common node voltage is near a full-scale value, an open circuit condition of the corresponding transistor is indicated; and
c) the full-scale value is configured as a maximum allowable bias voltage under specific operating conditions.

20. A battery management system, comprising the battery management module of claim 1, coupled to the battery.
